(19) United States
(12) Patent Application Publication
(10) Pub. No.: US 2013/0221742 A1
(43) Pub. Date: Aug. 29, 2013

(54) System for Harvesting Energy in Vehicles and Methods of Making and Using the Same

(71) Applicants: John L. PALUMBO, Wyckoff, NJ (US); Stephen A. BOYD, Manhasset, NY (US)

(72) Inventors: John L. PALUMBO, Wyckoff, NJ (US); Stephen A. BOYD, Manhasset, NY (US)

(21) Appl. No.: 13/407,048

(22) Filed: Feb. 28, 2012

(51) Int. Cl. B60L 1/00

(52) U.S. Cl. 307/9.1

(57) ABSTRACT

Organic polymer-based energy harvesting materials may be applied to any surface of a vehicle experiencing contortion, compression, mechanical stress and/or strain, and/or vibration during operation. An organic piezoelectric polymer film is applied to some or all of those parts of the vehicle that exhibit stress and/or strain associated with vehicle operation. Typical parts of the vehicle may include shocks, springs, control arms, and other points where one body or vehicle component is mounted to another, such as engine mounts or body mounts. A suitable rectifier may be coupled to the piezoelectric film to convert the AC signal generated by the piezoelectric film to a DC signal for use by the vehicle's onboard electrical system and/or a secondary electrical energy storage system (e.g., a battery).

### FIELD OF THE INVENTION

The present invention generally relates to the field of electric and/or hybrid vehicles. More specifically, embodiments of the present invention pertain to systems and methods for harvesting energy in a vehicle using piezoelectric devices.

### DISCUSSION OF THE BACKGROUND

A global push toward energy efficiency has driven many manufacturers to increase fuel efficiency with regard to vehicles (e.g., cars, trucks, motorcycles, commercial vehicles, trains, airplanes, etc.). Recent examples of electric vehicles (EV) such as the Nissan LEAF® and Tesla Motors line of electric vehicles, as well as various automaker designs of hybrid electric vehicles (HEV), all rely on maximizing on-board electrical energy generation to increase efficiency and/or increase the range per charge ratio. By reassessing the many parameters that may have an effect on fuel consumption, designers have improved efficiency of electric automotive vehicles. One design parameter that may have an effect on efficiency is the use of piezoelectric devices. A piezoelectric material is one that exhibits an electrical current when physically deformed.

Embedding a piezoelectric material within an automotive vehicle provides an opportunity to increase the energy efficiency by converting mechanical strain that is otherwise wasted into useful electrical work. Many points exist within the design and construction of any type of motor vehicle (e.g., cars, trucks, motorcycles, commercial vehicles, trains, airplanes, etc) where an electrical advantage can be realized by exploiting mechanical strain and/or vibrations that occur with the general operation of the vehicle.

One example of a piezoelectric material is poly(vinylidine fluoride) (PVDF). PVDF is a semi-crystalline polymer crystallizing in four crystal polymorphs referred to as α-, β-, γ-, and δ[1,2]-phases. The β-phase PVDF exhibits exceptional piezoelectric properties, which may be of interest in many 21st century technologies. A typical method for synthesizing β-phase PVDF includes uniaxial stretching of an α-phase film at nominal temperatures (e.g., ˜60° C.) while simultaneously exposing the α-phase film to electric fields >50 MV. Recently, β-phase PVDF doped with 2-15% (by weight) multi-walled carbon nanotubes (MWNT) has been synthesized without the use of uniaxial stretching or exposure to electric fields via an immersion precipitation technique using ethanol as an antisolvent.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

Embodiments of the present invention generally relate to systems and methods for embedding or forming piezoelectric films on motor vehicle surfaces exhibiting mechanical flexing and/or mechanical stress. More specifically, embodiments of the present invention relate to a system and method for harvesting energy by utilizing piezoelectric devices embedded within a vehicle that may be capable of producing electrical power when used in normal operation. Embodiments of the present invention advantageously utilize a PVDF polymer powder (e.g., Kynar® products, etc.). Orientation of the crystalline domains of β-phase PVDF may be essential to electrical energy harvesting. In some instances, the PVDF material may be synthesized in solution or dissolved in a solvent, and then applied to a suitable substrate (e.g., on one or more surfaces having appropriate vibrational and/or mechanical energies) to harvest electricity by the otherwise wasted mechanical energy of the motor vehicles. A multi-layered thin film (MLTF) of the organic piezoelectric material may be appropriately coupled to an appropriately configured rectifier to convert the alternating current (AC) signal generated by the piezoelectric film(s) to the vehicle's onboard direct current (DC) system and/or to a secondary electrical system.

A first aspect of the present invention relates to a system for harvesting power. In one embodiment of the present invention, a system for harvesting power comprises a piezoelectric film deposited onto one or more surfaces of a vehicle that exhibit mechanical strain, such as coil springs. The piezoelectric film is capable of producing electrical power when deformed due to vehicle operation. The system for harvesting power also comprises a power conditioning unit coupled to the piezoelectric film(s) via one or more electrical conductors, and an onboard electrical system (e.g., for storage of the generated electrical power, such as a battery). Electrical power is generated by the deformity of the piezoelectric film(s).

A second aspect of the present invention relates to a method of harvesting energy. In general, the method of harvesting energy comprises embedding a plurality of piezoelectric devices configured to produce electrical power in an operating motor vehicle, and connecting a power conditioning unit to the plurality of piezoelectric devices by electrical conductors. For example, a plurality of PVDF piezoelectric films (e.g., β-phase PVDF piezoelectric films, etc.) can be embedded in or at various contact points on the vehicle (e.g., motor mounts, springs, etc.). The driving or other normal operation of the vehicle creates a differential compression on the piezoelectric material at the point of contact such that the momentary strain induced by the normal force of the mount against the opposing weight force of the motor during vehicle operation produces a periodic deformity of the β-phase PVDF, and a resultant AC signal. The β-phase PVDF material may be coupled to a rectifier configured to convert the AC electrical signal to a DC electrical signal appropriate for on-board devices and/or one or more secondary storage systems (e.g., batteries). Consequently, electrical power can be generated from mechanical energy when the vehicle is in operation.

In exemplary embodiments, a β-phase PVDF material synthesized via a reverse emulsion technique is applied to some or all automotive structures where force and/or reversible deformity is imposed on the parts due to gravity, operation, or design. The β-phase PVDF material is applied to the automotive components either during the manufacturing of the components, or in the alternative, as a retrofit for an existing vehicle. In the case where β-phase PVDF is applied during manufacture, the β-phase PVDF material is applied using a known commercial process for coating, such as thermal spraying, spin coating, gel casting, chemical vapor deposition, or any other coating process known in the art. A rectifier may then be coupled to the coated piezoelectric material and/or film to convert an AC signal generated by the piezoelectric device to a DC signal for use or storage in the vehicle. The rectifier facilitates compatibility with the vehicular electrical system and/or feeds a secondary electrical storage device.

The present invention advantageously provides a system and method for harvesting electricity from the vibrational and/or mechanical energy of a vehicle as it used in normal operations. Furthermore, it is believed that the piezoelectric material and the application method thereof, as described herein may prevent or reduce corrosion (e.g., that may be caused by exposure to elements such as water, salt, air pollution, etc.) of the surfaces and/or structures on which the material is applied.

These and other advantages of the present invention will become readily apparent from the detailed description of various embodiments below.

### BRIEF DESCRIPTION OF THE DRAWINGS

FIG. 1A is a diagram showing the chemical formula of polyvinylidine difluoride (PVDF).

FIG. 1B is a second diagram showing an alternate chemical formula arrangement of PVDF.

FIG. 2 is a diagram showing examples of surfaces suitable for casting piezoelectric film.

FIG. 3 is a diagram showing a spring and shock assembly coated with a piezoelectric film and connected to an automotive frame.

FIG. 4 is a diagram illustrating the electrical effect of physical deformity of a piezoelectric material.

FIG. 5 is a diagram showing examples of points of mechanical compression suitable for application of a piezoelectric film.

FIG. 6 is a schematic of the front end of a car having piezoelectric films overlain on the joints.

FIG. 7 is a diagram showing suitable points for piezoelectric film application on a shock absorber.

FIG. 8 is a leaf spring assembly of a truck as it is mounted to the vehicle frame.

FIG. 9 is a diagram showing suitable mounting points on a vehicle frame for depositing piezoelectric film.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

Furthermore, all characteristics, measures or processes disclosed in this document, except characteristics and/or processes that are mutually exclusive, can be combined in any manner and in any combination possible. Any characteristic disclosed in the present specification, Claims, Abstract and Figures can be replaced by other equivalent characteristics or characteristics with similar objectives, purposes and/or functions, unless specified otherwise. Each characteristic is generally only an embodiment of the invention disclosed herein.

The headings used herein are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, where possible, similar reference numerals have been used to designate elements common to the figures. In the present disclosure, the term “deposit” (and grammatical variations thereof) is intended to encompass all forms of deposition known in the art, including blanket deposition, coating, and selective deposition (e.g., stenciling, embossing, printing, etc.).

For the sake of convenience and simplicity, the terms “motor vehicle,” “automotive vehicle,” and “vehicle” are generally used interchangeably herein, but generally refer to any motorized structure or device capable of moving, carrying, transporting, or otherwise conveying objects from one location to another. Also, for convenience and simplicity, the terms “stress,” and “strain” may be used interchangeably, but these terms are generally given their art-recognized meanings unless otherwise indicated. In addition, the terms “piezoelectric device” and “piezoelectric element” may be used interchangeably, and generally refer to a structure, component, or surface having a piezoelectric material and/or film deposited thereon or embedded therein.

The present invention concerns a system and method for harvesting energy. More specifically, embodiments of the present invention relate to a system and method for harvesting energy by utilizing piezoelectric materials deposited and/or embedded onto the surfaces of a motor vehicle (or components thereof) that exhibit mechanical flexing and/or mechanical stress (for example, vehicle components and/or surfaces exposed to mechanical stress and strain and/or that experience or generate mechanical vibrational energies). The piezoelectric materials are generally capable of inducing an AC electrical signal in the piezoelectric film deposited onto the aforementioned vehicle surface/component, thus producing electrical power when the vehicle is used in normal operation.

Various embodiments and/or examples disclosed herein may be combined with other embodiments and/or examples, as long as such a combination is not explicitly disclosed herein as being unfavorable, undesirable or disadvantageous. The invention, in its various aspects, will be explained in greater detail below with regard to exemplary embodiments.

An Exemplary System for Harvesting Energy

In one aspect, the present invention relates to a system for harvesting power or energy, comprising (a) one or more (e.g., a plurality of) piezoelectric devices capable of producing electrical power, each of the piezoelectric devices comprising an organic polymer having a non-zero piezoelectric capability; and (b) a power conditioning unit electrically connected to the piezoelectric device(s). In such a system for harvesting power, electrical power is generated in a vehicle (e.g., a car, truck, motorcycle, commercial vehicle, train, airplane, etc.) when it is in normal use.

In exemplary embodiments, the piezoelectric device(s) comprises (i) a base plate of flexible composite material; (ii) a top plate of flexible composite material; (iii) one or more piezoelectric elements capable of producing electrical power, positioned between the top plate and the bottom plate; and (iv) an elastic member connecting the base plate and the top plate and applying compression force on the plurality of piezoelectric elements. In certain implementations, the piezoelectric devices and/or piezoelectric elements comprise a PVDF material (e.g., a PVDF film, PVDF powder, etc.), which may be synthesized via solution or any other suitable method known in the art. The piezoelectric material may be applied to or embedded in the piezoelectric elements (e.g., by a coating or other deposition process described herein) between the top and bottom base plates. In general, any kind of binding member adapted to hold the base and top plates in place relative to each other can work. Furthermore, any surface or body that vibrates is also a candidate for an embedded piezoelectric device. Mechanical strain may take the form of physical compression, strain or vibration. In other words, vibration of the frame is capable of producing electrical current when equipped with an appropriately configured piezoelectric device.

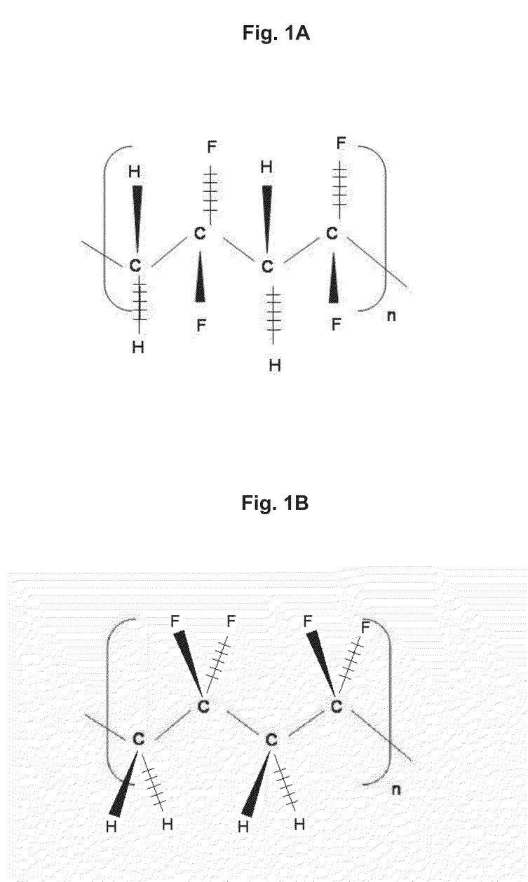

The piezoelectric material may comprise a PVDF powder (e.g., Kynar®) or any other plastic or organic (e.g., carbon-based) material having piezoelectric properties. For example, PVDF is a polymer chain made from repeating vinylidene difluoride CH₂—CF₂; VDF) monomer units, as shown in the chemical formulas shown in FIGS. 1A and 1B. In FIGS. 1A and 1B, the 3-dimensional repeating PVDF unit is depicted using stereochemistry conventions showing the Td sp³ carbon atoms with alternating hydrogen and fluorine atoms, respectively. Specifically, in FIGS. 1A and 1B, the fluorine and hydrogen arrangement depicts the β-phase PVDF, which can be used in exemplary piezoelectric devices of the present power harvesting system.

Although FIGS. 1A and 1B show β-phase PVDF, all of the phases of PVDF (e.g., α-, β-, γ-, and δ[1,2]-phase) have a distinct arrangement of neighboring fluoride atoms. For example, α-PVDF exhibits a TGTG′ (T-trans, G-gauche) arrangement of the next nearest neighboring fluoride atoms, β-PVDF exhibits a TTTT conformation with respect to the same neighboring fluoride atoms (as shown in FIGS. 1A and 1B), and γ-phase exhibits a TTTG TTG′ arrangement of neighboring fluoride atoms.

Due to the high electronegativity of fluorine and its relatively similar size to hydrogen (1.35 Å and 1.2 Å, respectively), electron density is drawn toward the fluoride groups in the polymer chain, resulting in a local net dipole moment of magnitude μ=6.4×10-30 C·m. The relatively small size of fluorine inhibits ordering of other phases. Thus, the β-phase arrangement may be preferred, whereas substitution of chlorine for fluorine, for example, induces gamma-phase conformations. By increasing the fluorine content in the polymer (e.g., by use of vinylidene fluoride/trifluoroethylene [VDF/TrFE] monomer mixtures in polymer synthesis), a gain may be had in the net dipole moment of the polymer sample. Thus, in various embodiments, the piezoelectric polymer may comprise a fluoroalkene polymer or copolymer, in which the fluoroalkene may be a C₂-C₁₀ (e.g., C₂-C₄) unsaturated hydrocarbon with one or more (preferably two or more) fluorine atoms covalently bound thereto and one or more sites of unsaturation (e.g., double bonds or triple bonds). In further embodiments, the fluoroalkene has at least one or two hydrogen atoms covalently bound thereto, and in some instances, up to about half of the hydrogen and fluorine atoms may be hydrogen atoms. Such polyfluoroalkenes generally have other beneficial mechanical and/or chemical properties, such as corrosion protection, wear resistance, mechanical damage protection, electrical insulation (at least when not undergoing changes in compressive forces, torsion, stress or strain), etc. However, in accordance with embodiments of the present invention, it has been demonstrated that the β-phase PVDF exhibits piezoelectricity on the order of 6 pC/N, which is about 10 times that of the next highest piezoelectric polymer.

In order to further optimize the piezoelectric and/or mechanical effects of the piezoelectric devices, the PVDF powder (e.g., β-phase PVDF, Kynar®, etc.) used in the piezoelectric elements may also be combined with one or more of the following: nanoclays, multi-walled carbon nanotubes (MWNT), MWNTs functionalized by the addition of any Group 1 alkali metal or other metal cation, and/or copper nanorods (also referred to as “PVDF nanocomposites”). Exemplary methods for synthesizing suitable piezoelectric materials may be described herein (see the section entitled “Exemplary Methods of Harvesting Energy”).

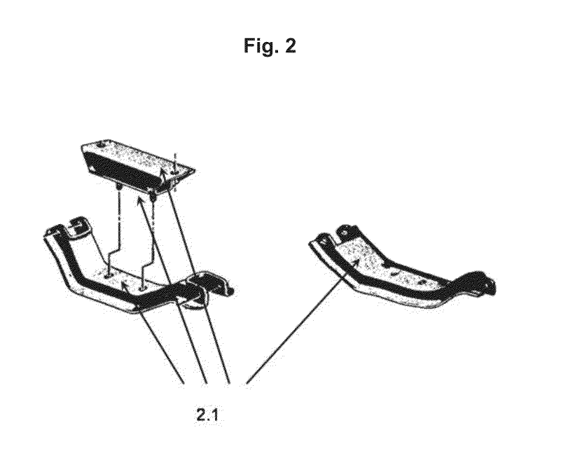

In exemplary systems, the piezoelectric material can be applied to, embedded in, or otherwise coated (e.g., as a piezoelectric film) on any surface of the vehicle that experiences or undergoes contortion and/or mechanical stress or strain during normal operation of the vehicle. For example, a piezoelectric film may be coated on or embedded in shocks, springs, control arms (e.g., rocker arms), and/or any point or location where one body or vehicle component is mounted to another body or vehicle component, such as engine mounts, body mounts, or any other suitable location in the vehicle. A variety of examples are shown in FIGS. 2-3 and 5-9, as described herein.

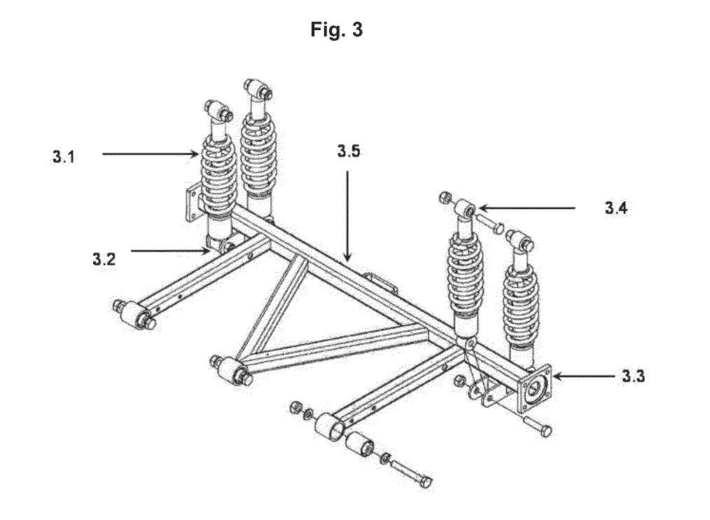

FIG. 2 is a diagram showing various surfaces 2.1 of a motor or engine mount suitable for casting a piezoelectric film, where mechanical strain and/or stress may be imposed on the motor/engine mounts to produce electricity. In another example, spring and shock assemblies connected to automotive frame are shown in FIG. 3. In this embodiment, a spring shock 3.1 has a coating of β-phase PVDF on at least the springs, as described herein. As the spring 3.1 flexes from normal use, the β-phase PVDF polymer coating on the spring 3.1 produces a current or AC signal, which then is fed into a suitable rectifier (not shown) by one or more wires (also not shown) electrically connected to the polymer coating by a metal bonding pad adhered to or deposited onto the polymer coating. The rectifier is configured to convert an AC signal to a DC signal, which then joins (e.g., provides the generated electricity to) the onboard electrical system (or other secondary system, such as a battery) of the vehicle. Other components, such as rotatable mounting joints 3.2 and 3.4, may be coated with an organic piezoelectric polymer or have an organic piezoelectric polymer embedded therein. Components such as rear frame section 3.5 or fixed mounting joint 3.3 may have an organic piezoelectric polymer coated thereon or embedded therein.

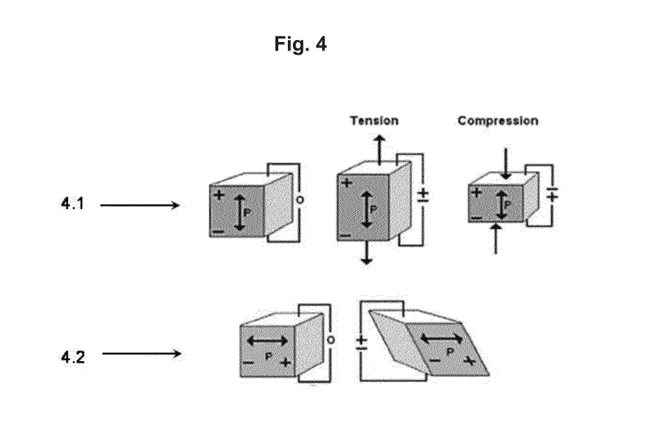

The diagrams shown in FIG. 4 illustrate the electrical effect of physical deformity of a piezoelectric polymer material (e.g., the β-phase PVDF polymer coating on the spring 3.1 of FIG. 3). For example, FIG. 4.1 shows the resultant electrical potential P as a result of tension and compression (e.g., as applied to a spring during the operation of a vehicle). FIG. 4.2 shows the resultant electrical potential P that results from shearing forces.

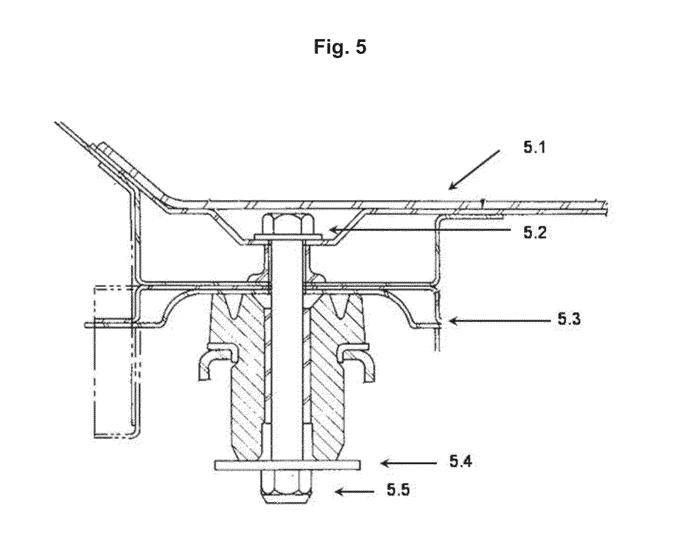

As shown in FIG. 5, a piezoelectric film may be coated on or applied to an assembly for securing the body 5.1 of a vehicle to the frame 5.3. In such embodiments, reference characters 5.2, 5.4, and 5.5, are each points of mechanical compression that may be suitable for application of an organic piezoelectric polymer film.

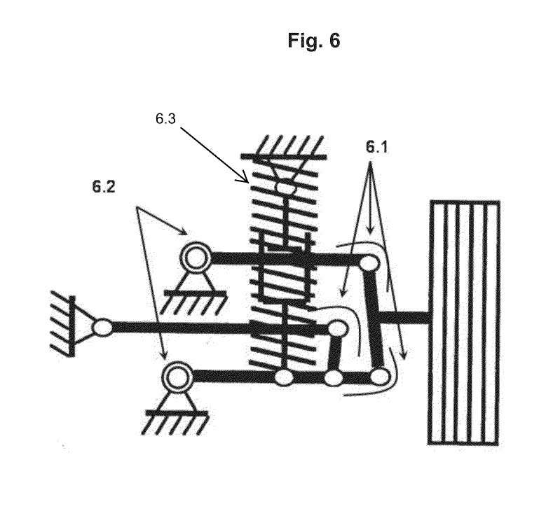

FIG. 6 is a diagram of a vehicle front end (e.g., the steering mechanism and wheel portion on one side of a car). In this embodiment, one or more organic piezoelectric polymer films are formed on or embedded in the joints 6.1, steering mechanism 6.2 and shock/spring 6.3 such that the flexing organic piezoelectric polymer films deform and produce an electrical potential when the vehicle is in operation.

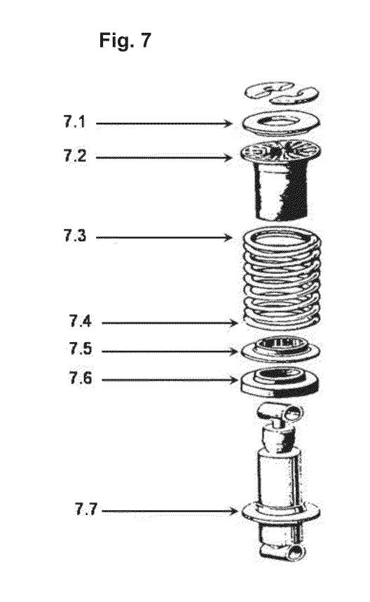

Yet another example is shown in FIG. 7, which depicts an expanded view of a shock absorber. In this embodiment, each of reference characters 7.1-7.7 represents points suitable for piezoelectric film application. Each of these points 7.1-7.7 exhibit exemplary mechanical strain suited for enabling the piezoelectric generation of electrical power described herein.

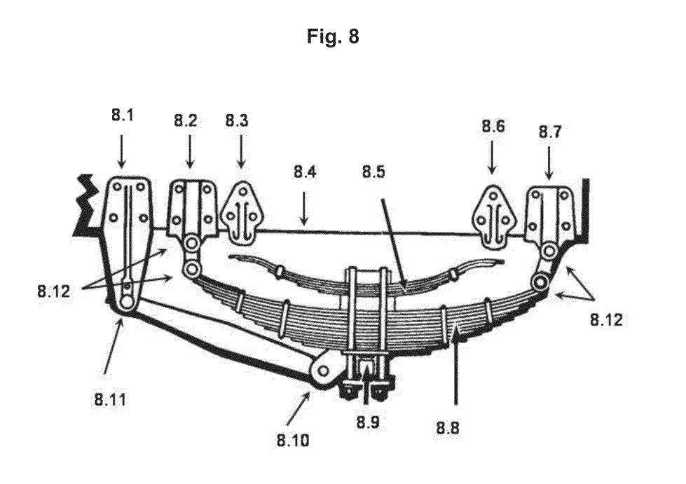

FIG. 8 shows a leaf spring assembly for a truck as it is mounted to the frame. In the leaf spring of FIG. 8, mounting points 8.1, 8.2, 8.3, 8.6, and 8.7 for attaching the suspension system to the frame 8.4 are each locations that exhibit exemplary shear, strain, tension and/or compression capable of producing an electric potential when coated with an organic piezoelectric polymer film. The resultant electrical potential P resulting from such forces is shown in FIG. 4.2. In addition to the mounting points 8.1, 8.2, 8.3, 8.6, and 8.7, a piezoelectric film may also be coated on or embedded in the leaf spring apparatus 8.5 and 8.8 (e.g., between adjacent plates thereof). When flexed, the piezoelectric film-coated or piezoelectric device-embedded leaf spring structures 8.5 and 8.8 enable production of electrical energy.

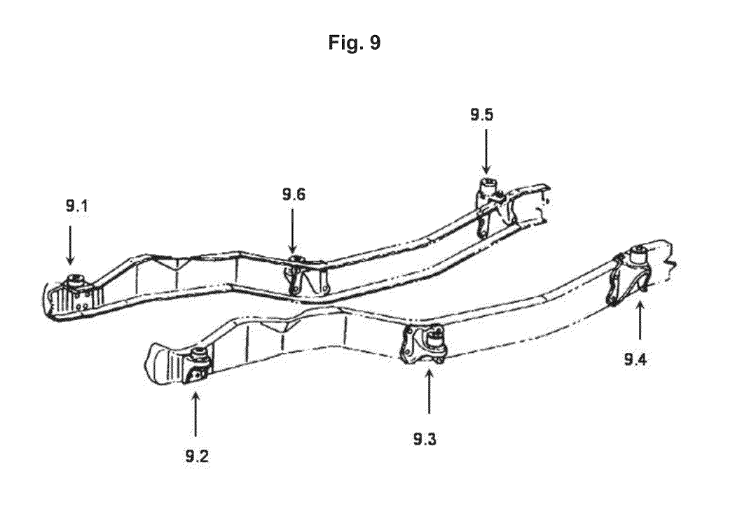

Referring still to FIG. 8, joints 8.9, 8.10, 8.11, and 8.12 depict moving mounting points, that, when covered with an organic piezoelectric polymer film, are capable of producing electrical energy with normal vehicle use. In another example, FIG. 9 depicts mounting points 9.1-9.6 on a vehicle frame that are suitable for depositing or embedding a piezoelectric film to produce electrical energy from the mechanical stresses imposed thereon or imparted thereto from the body weight and/or movement of the vehicle.

The system further comprises a power conditioning unit connected to the piezoelectric films and/or devices. The power conditioning unit and the piezoelectric device are connected by one or more electrical conductors (e.g., electrodes and wires). The electrical conductors are appropriately connected, either by hard wiring or wireless transfer, to inverters that maximize the DC output from the AC MLTF input sources, thus creating electrical circuitry in parallel, in series, or in one or more combinations thereof. The electrical conductor(s) may comprise any suitable conductive material known in the art. For example, suitable conductive materials may include, but are not limited to elemental metals, such as aluminum, titanium, vanadium, chromium, molybdenum, tungsten, iron, nickel, palladium, platinum, copper, zinc, silver, gold, etc., and conventional alloys of such elements, such as aluminum-copper alloys, aluminum-titanium alloys, iron alloys such as (stainless) steel, etc.

In embodiments in which the electrical conductors are hard-wired to both the organic piezoelectric polymer and the power conditioning unit, the electrodes may be directly connected to the piezoelectric material, element and/or device. The electrode may comprise a pad (e.g., a circular or square layer or film having an area of 1-10 mm²) of metal, alloy or other electrically conductive material (e.g., an electrically conductive metal compound, such as a metal nitride and/or silicide [e.g., titanium nitride, titanium silicide, tantalum nitride, cobalt silicide, molybdenum silicide, tungsten silicide, platinum silicide, etc.]) attached to or deposited on the piezoelectric material. The metal or alloy may be as described above. The electrode may be attached by adhering the pad to the piezoelectric material using a conductive adhesive. Alternatively, if the pad is deposited (e.g., by selective deposition), an appropriate (e.g., conductive) bonding material may be deposited onto the piezoelectric material before the electrode material is deposited. The wire may be attached (e.g., by soldering) to the pad and to the power conditioning unit.

In embodiments comprising wireless energy transfer, a first antenna or other wireless transmitter may be attached to the electrode, and a second antenna or other wireless transmitter configured to receive electrical power from the first antenna/wireless transmitter may be conventionally attached to the power conditioning unit. The first antenna or transmitter is generally configured to transmit the electricity or power generated by the piezoelectric material to a remote receiver comprising the second antenna. In general, the receiver and transmitter are from about 1 mm to about 1 m (e.g., 10 mm to 1 cm, or any other distance or range of distances therein) apart from one another. Suitable receivers and/or transmitters are known in the art and are commercially available.

In exemplary embodiments, the electrical conductors are connected to an onboard vehicle power system and/or a secondary power storage unit. For example, in some embodiments, the electrical conductors are generally configured to feed or transfer the electrical energy generated from the piezoelectric polymer directly to the automotive electrical or power system. In some instances, it may be both energetically and financially desirable to employ one or more secondary storage devices (e.g., batteries) to store the electricity for later, modified, or alternatively voltage- or frequency-directed usage. In such instances, the electrical conductor(s) may additionally or alternatively be configured to transfer or feed the electrical energy generated from the system to a battery such as a nickel/cadmium, metal-hydride, lithium-ion, lead-acid, vanadate or other type(s) of battery for storage. Alternatively or additionally, the energy generated by the system may be stored in any other high-voltage storage system(s) known in the art, such as resistive-mediated capacitor arrays or the like.

In exemplary embodiments, the power conditioning unit may comprise a rectifier coupled to the coated piezoelectric material and/or film. The rectifier is generally configured to convert an AC signal generated by the piezoelectric device and/or antenna to a DC signal, and facilitates compatibility with the onboard electrical system of the vehicle. Additionally or alternatively, the rectifier can be configured to supply the converted DC signal for storage in the secondary storage device.

An Exemplary Method of Harvesting Energy

The present invention further relates to a method of harvesting energy or power. In general, the method comprises (a) embedding one or more (e.g., a plurality of) piezoelectric devices comprising an organic piezoelectric polymer in a motor vehicle, wherein the piezoelectric devices are capable of producing electrical power when the vehicle is in normal operation, and (b) electrically connecting a power conditioning unit to the piezoelectric device(s). The plurality of piezoelectric devices can be used to harvest energy in vehicles such as cars, trucks, motorcycles, various commercial vehicles, trains, airplanes, or any other vehicle capable of producing vibrations, stress, or strain during normal operations. Thus, the method may comprise operating a vehicle having the present system for harvesting power or energy operably placed or embedded therein.

In exemplary embodiments, a piezoelectric material, such as a PVDF polymer or other plastic or organic polymer having piezoelectric properties can be applied to, embedded in, or otherwise deposited on elements, surfaces, and/or components of a vehicle that are capable of producing or experiencing contortion, vibration, and/or mechanical stress or strain during the operation of the vehicle. For example, the method may comprise depositing (e.g., selectively or blanket-depositing) the piezoelectric material on shocks, springs, leaf springs, assemblies, control arms, attachment points, or other points or locations where one vehicle component is mounted on or to another (e.g., engine mounts, body mounts, frame attachment sites, etc.). Examples of suitable locations for application of the piezoelectric material are shown in FIGS. 2-3 and 5-9 and are described herein with regard to exemplary systems.

In exemplary embodiments, the organic piezoelectric polymer material is as described herein. For example, in some implementations, β-phase PVDF may be preferred since β-phase PVDF exhibits piezoelectric properties that are about 10 times greater than that of the next highest piezoelectric polymer.

In some embodiments, the method may comprise making the organic piezoelectric polymer. For example, in a typical synthesis of PVDF, the α-phase is made using an addition chemical reaction involving VDF monomers, which results in the α-phase arrangement. In some variations, the β-phase structure can be produced by uniaxial stretching of the α-phase material while simultaneously exposing it to static electric fields on the order of 20 kV to 100 MV. Depending on the thickness of the material, in addition to exposure to static electric fields, heating the material to below the Tg temperature aids in the fabrication of the piezoelectric β-phase polymer.

In one embodiment of the present method, β-phase PVDF may be synthesized by adding approximately 2% by weight of multi-walled carbon nanotubes (MWNT) to the composition. For example, in such embodiments, MWNT can be mixed in solution with PVDF powder (e.g., Kynar®), and then precipitated using ethanol as an antisolvent. Such embodiments advantageously enable synthesis of piezoelectric β-phase PVDF without the need for uniaxial stretching and poling. In some embodiments, β-phase PVDF may be synthesized using an immersion precipitation technique. In such embodiments, ethanol is used as an antisolvent, and as previously described, piezoelectric β-phase PVDF can be synthesized without the need for uniaxial stretching and poling or exposure to electric fields.

In some implementations, the PVDF polymer powder may be combined with one or more nanoclays, MWNTs, MWNTs including a Group 1 alkali metal (or other metal cation) functional group, copper nanorods, or any combination thereof. Generally, the orientation of the crystalline domains of β-phase PVDF is important to electrical energy harvesting, and is enhanced by the addition of such dopant materials. Consequently, such PVDF nanocomposites may further optimize the piezoelectric properties and/or electrical energy generating capability of the PVDF or other organic piezoelectric polymer material.

In exemplary implementations, the PVDF material is applied to a suitable substrate or surface of the interior and/or exterior of the automotive vehicle or component(s) thereof. As previously described, the PVDF material can be applied to or embedded in elements, surfaces, and/or components of a vehicle that are capable of undergoing contortion, vibration, and/or mechanical stress or strain during the normal operation (e.g., shocks, springs, assemblies, control arms, engine mounts, attachment points, etc.). However, it is believed that structures and/or components of a vehicle that experience temperature extremes (e.g., an exhaust manifold or tail pipe) may not provide optimal energy harvesting results.

In some implementations, the organic piezoelectric polymer can be applied by depositing a liquid-phase composition comprising the organic piezoelectric polymer on the surface(s) of the desired element or component. The organic piezoelectric polymer can be deposited during the manufacture of the vehicle, or alternatively, the organic piezoelectric polymer can be applied during retrofitting of an existing vehicle.

The liquid-phase organic piezoelectric polymer composition can be deposited by any conventional or commercial blanket deposition technique or process, or any selective deposition technique known in the art. For example, suitable conventional blanket deposition technique may comprise thermal spraying, gel casting, chemical vapor deposition (CVD), low pressure CVD, sputtering or other physical vapor deposition (PVD) techniques, spin coating, spray coating, immersion coating, etc. Selective deposition techniques may include embossing, stenciling, printing processes such as inkjet printing, screen printing, gravure printing, offset printing, or flexography (flexographic printing), spray coating, slit coating, extrusion coating, meniscus coating, microspotting, pen-coating, syringe dispensing and/or pump dispensing.

In exemplary embodiments, the piezoelectric device(s) are positioned in the vehicle, and the relevant electrical connections between the piezoelectric device(s) and the electrical conductors are made. In general, the electrical conductor(s) are connected to one or more inverters, for example by soldering. Alternatively, the method may comprise connecting an antenna or wireless receiver to the inverter(s). The inverter(s) maximize the DC output from the AC MLTF input sources and electrical circuitry is created. The various electrical power generating, usage and/or storing circuits may be connected in parallel, in series, or in one or more combinations thereof.

In embodiments wherein the electrical connections are hard wired, the electrical conductors (e.g., electrodes) are deposited on and/or directly connected to the piezoelectric material, element and/or device using any method known in the art. For example, a metal or other conductor can be adhered to the piezoelectric material or film with a conductive adhesive or glue. In other instances, a metal or conductive material can be deposited on the piezoelectric material or film by CVD, sputtering, or any other suitable deposition technique described herein. In some cases, excess conductive material can be removed by scraping or selective chemical removal (e.g., masking and etching). A wireless transmitter and/or antenna can be attached to the conductive material for wireless transfer to a remote receiver for electrical power using any method known in the art (e.g., soldering, etc.). The receiver is generally positioned about 1 mm to 1 m (e.g., 1 mm, 5 mm, 1 cm, 0.5 m, or any value or range of values therein) from the antenna or other transmitter. Implementations in which the transmitter and receiver are relatively close together result in a more efficient transfer of electrical energy.

In exemplary implementations, the method may further comprise feeding or transferring the electrical energy generated from the piezoelectric device (and the power conditioning unit electrically connected thereto) to an onboard automotive electrical system. Alternatively or additionally, the method may comprise transferring and/or storing some or all of the harvested energy from the system in or to one or more storage devices, as described herein (e.g., a battery such as a nickel/cadmium battery, a high-voltage storage system such as a resistive-mediated capacitor array, etc.). In such embodiments, the method may further comprise coupling a rectifier to the piezoelectric material and/or film to convert the AC signal generated by the piezoelectric device to a DC signal. The rectifier may facilitate compatibility with the onboard electrical system of the car and/or may supply a DC signal to the electrical storage device(s).

### CONCLUSION/SUMMARY

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A system for harvesting power in a vehicle, comprising:
a) one or more piezoelectric devices capable of producing electrical power when the vehicle is in operation or normal use, the piezoelectric device(s) comprising an organic piezoelectric polymer; and
b) a power conditioning unit electrically connected to the piezoelectric devices.

2. The system of claim 1, wherein the power conditioning unit is connected to an onboard power system.

3. The system of claim 1, wherein the power conditioning unit is connected to a power storage unit.

4. The system of claim 1, wherein each of the piezoelectric device(s) comprises:
a) a flexible base plate;
b) a flexible top plate;
c) one or more piezoelectric elements between the top plate and the bottom plate, each of said piezoelectric element(s) being capable of producing electrical power; and
d) a member connecting said base plate and said top plate and exerting stress, strain and/or a compressive force on the piezoelectric element(s).

5. The system of claim 1, wherein the piezoelectric device(s) comprise a polyvinylidene fluoride coating or film.

6. The system of claim 5, comprising β-phase polyvinylidene fluoride.

7. The system of claim 6, wherein the β-phase polyvinylidene fluoride further comprises a dopant selected from the group consisting of nanoclays, multi-walled carbon nanotubes, multi-walled carbon nanotubes having a Group I alkali metal or metal cation, copper nanorods, and combinations thereof.

8. The system of claim 1, wherein the organic piezoelectric polymer is on one or more components of the vehicle selected from the group consisting of a shock assembly, a spring assembly, a leaf spring, a control arm, and attachment points for securing one vehicle component to another vehicle component.

9. The system of claim 1, further comprising an antenna or transmitter electrically connected to the piezoelectric device(s), wherein the antenna or transmitter is configured to wirelessly transmit harvested power to a receiver.

10. The system of claim 1, further comprising a rectifier coupled to the piezoelectric device(s), wherein the rectifier is configured to convert an alternating current generated by the piezoelectric device(s) to a direct current.

11. The system of claim 1, further comprising a storage system configured to receive and store harvested power.

12. A method of harvesting energy in a vehicle, comprising:
a) placing or embedding one or more piezoelectric devices capable of producing electrical power when the vehicle is in operation or normal use, the piezoelectric device(s) comprising an organic piezoelectric polymer; and
b) electrically connecting one or more power conditioning units to the piezoelectric device(s).

13. The method of claim 12, wherein placing or embedding a plurality of piezoelectric devices comprises:
a) forming a coating or film of said organic piezoelectric polymer on one or more components or surfaces of said vehicle that; and
b) making electrical connections to said coating or film and the power conditioning unit.

14. The method of claim 12, further comprising:
a) synthesizing a β-phase polyvinylidene fluoride composition; and
b) depositing the β-phase polyvinylidine fluoride composition on one or more interior and/or exterior surfaces of the motor vehicle.

15. The method of claim 14, wherein depositing the β-phase polyvinylidine fluoride composition comprises sputtering, spin coating, spray coating, thermal spraying, gel casting, chemical vapor deposition, physical vapor deposition, or printing the β-phase polyvinylidene fluoride composition on the interior and/or exterior surface(s) of the motor vehicle.

16. The method of claim 12, comprising wireless transferring the electrical power produced by the piezoelectric device(s) to a remote receiver electrically connected to the power conditioning unit(s).

17. The method of claim 12, further comprising collecting and/or using the produced electrical power in the vehicle.

18. The method of claim 17, comprising transferring the produced electrical power to an onboard electrical system in the vehicle.

19. The method of claim 17, comprising storing the produced electrical power in a storage device.

20. A method of harvesting energy in a vehicle, comprising:
a) operating the vehicle in a manner producing electricity from one or more piezoelectric devices operably placed or embedded in the vehicle, the piezoelectric device(s) comprising an organic piezoelectric polymer; and
b) collecting or using the electricity produced by the piezoelectric device(s) in an onboard electrical system or in a storage device in the vehicle.
